(19) United States
(12) Patent Application Publication
(10) Pub. No.: US 2001/0027956 A1
(43) Pub. Date: Oct. 11, 2001

(54) Infant feeding device

(76) Inventors: Frank Bonacorso, West Hampstead (GB); Gerard Mark Egan, West Hampstead (GB)

Correspondence Address: HESLIN ROTHENBERG FARLEY & MESITI PC, 5 COLUMBIA CIRCLE, ALBANY, NY, 12203, US

(21) Appl. No.: 09/761,442

(22) Filed: Jan. 16, 2001

Related U.S. Application Data
(63) Continuation of application No. PCT/GB99/02297, filed on Jul. 15, 1999.

(30) Foreign Application Priority Data
Jul. 15, 1998 (GB) 9815265.5

(51) Int. Cl. A61J 9/00; A61J 11/00; B65D 83/00; B65D 23/10

(52) U.S. Cl. 215/11.1; 215/388; 215/396; 215/11.4

(57) ABSTRACT

This invention relates to an infant feeding device comprising a mouthpiece adapted to deliver liquid feed to an infant, a grip member shaped to be easily grasped by an infant and means for connecting the mouthpiece to a feed reservoir. A kit for feeding an infant which comprises an infant feeding device as described above, a feed reservoir and a tube which communicates with both the reservoir connection means and the feed reservoir is also provided together with a feed reservoir for use in such a kit.

This invention relates to an infant feeding device and, in particular, to the kind for use with liquid feed, a kit for feeding an infant and a feed reservoir for use in such a kit.

There are several clear stages of feeding an infant, each of these stages fundamentally linked to the physical development of the infant. Firstly, there is breastfeeding where an infant is solely reliant on the mother, usually followed by bottle feeding where again an infant is reliant upon the mother or carer to elevate and hold the bottle or cup containing a liquid to enable it to feed. Finally, it graduates to holding the bottle or cup independent of its mother or carer and feeds itself.

During the first stages of feeding, whether it is breast feeding or dependant bottle feeding, infants do not possess either the dexterity or the strength to hold and feed from a bottle or cup. Nevertheless, at this point of development, although unable to independently hold and feed from a bottle or cup, an infant possesses a strong grip. However, the current infant feeding methods do not adequately take advantage of the pronounced grip skills infants are endowed with from birth.

The most common infant feeder is of the bottle type for liquid feed where there is generally a reservoir bottle for containing the liquid feed and a mouthpiece mounted on the opening of the reservoir. The reservoir is usually made of a stiff plastic material and the mouthpiece is usually made of moulded silicone. The feed runs under gravity from the reservoir into the teat where the infant feeds by sucking and stripping the teat with its tongue. This type of mouthpiece usually has several small holes or other apertures such as slits in the moulding to allow the egress of feed into the infant's mouth. However, there are a number of disadvantages associated with such bottle type feeders.

First, the flowrate for this type of feeder is determined by the apertures in the mouthpiece and cannot be varied. Thus, several teats with varying flowrates are required as the infant grows up to keep pace with their feeding requirements. For instance, a teat with a smaller flowrate is required for younger infants to prevent the infant from ingesting too much feed at once and choking However, the same teat would not be ideally suited for older infants. Another factor against the suitability of these feeders for infants of all ages is the fact that there is usually no valve mechanism to prevent the feed from flowing out of the teat when there is no suction being provided by the infant. Thus, when baby feeding bottles of this kind are inverted, a steady amount of fluid will leave the teat. Again, in order to prevent the younger infant from choking on the feed, it is usual for a teat with a smaller flowrate to be used initially, and replaced later on with a teat with a larger flowrate.

Another drawback of these feeders when they are used by infants on their own is that, due to their design, all the weight of the liquid feed is carried by the infant. A full bottle of average size is a considerable weight to be held aloft by the infant. Since these bottles operate by gravity flow, the bottle has to be inclined for the feed to flow. Whilst in reality the infant will usually be in a reclining position in order to reduce the amount of inclination of the bottle required, it is still an effort on the part of the infant to hold the bottle up for the time it takes to feed. Furthermore, there is usually an amount of feed left in the bottle at the end of feeding, either as a result of the infant not being able to raise the bottle sufficiently to let the remaining feed run down into the teat, or the infant being too tired to keep the bottle aloft, or a combination of the two. Also, as a result of the need to constantly keep the bottle inclined to provide feed to the teat, the infant usually ingests an amount of air from sucking when the feed is not in the teat due to the bottle not being inclined sufficiently, and the teat consequently containing air. This results in the infant getting “wind” and remedial action having to be taken by the carer.

These feeders are further not ideally suited for use by infants in that they are generally too big for an infant to grasp comfortably. Moreover, such feeders are not designed to take advantage of the considerable gripping skills inherent in infants nor do they further develop these skills.

There are similar problems for an adult feeding an infant with such a bottle type feeder in that the bottle has to be kept aloft in a downward pointing direction and held there for the duration of feeding. The adult is further inconvenienced by having to use one hand to hold the bottle and thus only having one hand free to look after the infant and keep it in the right position. It is much less tiring and also much safer for an adult to be able to support the infant in both arms.

Feeding bottles are also known which have a rigid spout, usually made from a plastics material, with apertures in the spout for letting out feed. This type of feeding device is intended for an older infant with a view to training the infant to use a cup, which has a hard rim. Such products effectively comprise a tumbler, with one or more handles, provided with a lid and a rigid spout. Many different types are available with different sized handles, different shaped spouts and different sized cup bodies to encourage the infant to learn to grip the cup by the handle and drink from it. These devices are designed to be as leakproof as possible so that, when the infant drops or knocks the cup over whilst getting used to gripping handles, very little liquid feed is spilled. However, a major disadvantage of such devices is the fact that the infant has to bear the entire weight of the cup and the feed. Accordingly, such devices can only be used once an infant has acquired sufficient strength to lift and hold such a cup.

Clearly, it is advantageous for an infant to learn feeding skills as soon as possible. However, due to their weight and size, known devices are difficult for an infant to lift and hold. Moreover, such known devices do not exploit the grip skills inherent in all infants. It is thus an object of the present invention to bridge the gap from breast or dependent bottle or cup feeding to the infant holding a bottle or cup by itself. It is a further object of the invention to develop the grip and coordination skills required by an infant to eventually hold and feed from a cup or bottle with handles.

According to the present invention there is therefore provided an infant feeding device comprising a mouthpiece adapted to deliver liquid feed to an infant, a grip member shaped to be easily grasped by an infant and means for connecting the mouthpiece to a feed reservoir. The term “feed” as used herein includes liquid food, drinks, paediatric medicines, and mixtures thereof.

It is preferred that the mouthpiece is adapted to regulate the flow of liquid feed to the infant. This may be achieved in a variety of ways. For instance, the number and/or size of feeding apertures in the mouthpiece can be varied. Furthermore, some or all of the apertures may be constructed so that they only allow fluid flow through them when the infant provides a force against the mouthpiece, perpendicular to the main axis of the mouthpiece and concurrent with the forces present when an infant is stripping or biting the mouthpiece. Preferably, the mouthpiece is a flexible teat, such as a silicone teat or a rigid spout, preferably made of a plastics material. However, other types of mouthpiece may be readily envisaged.

The grip member may be of any shape provided it can be easily grasped by an infant. However, it is preferred that the grip member comprises at least one generally elongate element preferably having a cross-section which is sufficiently small for an infant's hand to be able to grasp it. In one preferred embodiment, the grip member comprises at least one closed loop of a size which allows it to be easily grasped by an infant. Alternatively, the grip member could comprise one or more rods or tapering rods, which are preferably curved to fit the hand of an infant better. It is envisaged that such elongate elements could serve a dual purpose by functioning as a hanging means to allow the feeding device to be hung on a suitable part of the surroundings when not in use in such a way that the feeding device does not touch any surfaces and therefore remains unsoiled. Such an arrangement could be useful in a situation where the infant is in a perambulator, a walking device or in a child seat in an automobile so that, when the infant has temporarily stopped feeding, the feeding device can be temporarily secured to a suitable support so that it is not dislodged during motion. In another preferred embodiment the grip member comprises one or more wings or tabs of generally planar construction. These wings or tabs may be moulded to include grooves corresponding to the shape of an infant's fingers to facilitate grasping of the wings or tabs.

The infant feeding device of the present invention may be formed in a single piece, preferably of a suitable plastics or silicone rubber material. However, it is preferred that the individual components are detachable from one another to facilitate cleaning of the device and replacement of the mouthpiece by another mouthpiece having different characteristics, such as different flowrate, degree of softness etc..

In one preferred embodiment, the device further includes a tubular adaptor which is capable of receiving the mouthpiece. Preferably, the tubular adaptor is also capable of engaging the reservoir connection means. However, as an alternative, the device may be provided with a tubular connector which is capable of engaging both the tubular adaptor and the reservoir connection means.

In one form, the tubular adaptor may comprise a collar having a flange at one end which is perpendicular to the axis of the collar and has an aperture in the flange of a size such that a mouthpiece having a corresponding flange may be fitted in a manner so that the mouthpiece projects through the aperture in the flange of the collar and the corresponding flange of the mouthpiece abuts the reverse side of the flange of the collar thereby holding the mouthpiece in position within the collar. The collar may also be screwthreaded at the unflanged end so that it can be secured to the reservoir connection means by means of a corresponding screw thread on the reservoir connection means. Alternatively, the collar may be secured to a tubular connector by means of a corresponding screw thread and the tubular connector may be secured to the reservoir connection means, for instance, by appropriately corresponding screw threads.

The grip member may be attached to any part of the device. However, it is preferred that the grip member is attached to the reservoir connection means, the mouthpiece, the tubular adaptor or the tubular connector. The grip member may be formed as an integral part of the reservoir connection means, the mouthpiece, the tubular adaptor or the tubular connector. However, it is preferred that the means of attachment is a temporary one to facilitate cleaning. Alternatively, the grip member may be attached to an annulus which is adapted to engage the mouthpiece, reservoir connection means, tubular adaptor or tubular connector, for instance, by fitting over a suitable projection on any of these elements.

Preferably the feeding device contains a liquid flow control device to prevent backflow of feed and thus prevent the ingress of air into the mouthpiece. Consequently, the liquid flow control device allows the infant to ingest less air when feeding from a feeding device according to this invention. The liquid flow control device can also serve to regulate the flow of liquid feed to the mouthpiece. Preferably, the liquid flow control device comprises a valve. In embodiments where a rigid spout is utilised, a valve can also be incorporated in the spout itself. Clearly, any suitable valve may be utilised in the device of the invention provided that there is little or no leakage from the mouthpiece when in an inverted position, that is, with the tip of the mouthpiece pointing downwards.

In one embodiment, it is preferred that the valve comprises a mushroom valve. It is further preferred that the mushroom valve is mounted in an insert which is adapted for mounting in the feeding device. When sufficient suction is applied to the mouthpiece and the pressure drop across the valve in the direction of flow of the feed reaches a predetermined level, the periphery of the mushroom valve rises above the surface on which it rests and creates a channel through which feed can flow. When suction is removed and the pressure drop recedes below a predetermined level, the periphery of the mushroom valve regains its original position and closes the channel.

In another embodiment, it is preferred that the valve comprises a slit valve. Preferably, the slit is in the form of a cross. It is further preferred that the slit valve is mounted in an insert which is adapted for mounting in the feeding device It is also preferred that the slit valve is inwardly domed, that is, domed in a direction against the direction of flow of the feed when the feeding device is in use. When sufficient suction is applied to the mouthpiece such that the pressure drop across the slit valve in the direction of flow of the feed reaches a predetermined level, the slit opens and allows feed to flow. When suction is removed and the pressure drop recedes below a predetermined level, the slit closes again preventing further feed from flowing.

Where the valve is mounted in an insert, it is also envisaged that the reservoir connection means could be attached to the valve insert. Alternatively, the mouthpiece may be attached to the valve insert and the reservoir connection means may also be attached to the valve insert on the opposite side of the insert to the mouthpiece. It is preferable in this embodiment that the means for attachment on both sides of the insert is the same. For instance, it is envisaged that the connecting means may take the form of a screw thread or a push fit arrangement. With the attachment means being the same on both sides of the insert, the valve insert could be used in either orientation, that is, it is effectively reversible. Preferably, the valve utilised in this embodiment is integral with the insert.

In a further preferred embodiment, multiple valves may be employed such that the flowrate and/or the pressure required to activate flow through the valves may be different with one orientation of the valve insert as compared to the other orientation. The differences may arise from having more valves operating in one flow direction than in the other flow direction, or it may arise from having valves of different activation pressures and/or flowrates. In this embodiment, the valve insert may have two modes of use and may allow the feeding device to be suitable for a growing infant over a longer period when compared to previous feeders. The mouthpiece in this embodiment could be attached to the valve insert by means of a collar. Preferably, the grip member is integral with or attached to an annulus which is secured between the valve insert and a threaded component, or it may be integral with or attached to the valve insert itself.

It is preferred that the device further includes for reducing or preventing air from entering the mouthpiece to ensure that suction is unimpeded. This may comprise an insert which serves to compress the mouthpiece against the tubular adaptor. However, this function may also be performed by a valve insert as described above.

Preferably, the reservoir connection means comprises a tubular spigot to which a feed tube may be connected to provide feed from a feed reservoir. It is preferred that the feed tube fits with the spigot by an interference fit, tightly enough to prevent an infant from disconnecting the tube, but easily enough for an adult to dissemble the two parts for cleaning. It is further preferred that the spigot is provided with a ridge to assist in securing the tube. It is also preferred that there is a corresponding groove or ridge on the surface of the feed tube adjacent to the spigot to temporarily lock the tube in place. Again, the fit provided should be strong enough to prevent an infant from dislodging the feed tube from the tubular connector, but should still allow the tube and spigot to be easily dissembled by an adult for cleaning purposes.

In a further embodiment, the feeding device may be provided with means for attaching a strap of a size such that it can be worn comfortably around an infant's neck. This allows the feeding device always to be readily at hand for the infant to resume feeding after an interruption or if the feeding device has fallen from the infant's mouth.

According to another aspect of the present invention there is provided a kit for feeding an infant which comprises a mouthpiece adapted to deliver liquid feed to an infant, a feed reservoir, means for connecting the mouthpiece to the feed reservoir, a tube which communicates with both the reservoir connection means and the feed reservoir and a grip member shaped to be easily grasped by an infant.

It is envisaged that the grip member could be attached to the mouthpiece, the feed reservoir, the reservoir connection means or the tube or could be formed as an integral part of any of these elements. If the grip member is to be attached to the tube, it is preferred that the grip member be attached to a portion of the tube which is close to or adjacent the mouthpiece or reservoir connection means. Ideally, the tube or the portion of the tube to which the grip member is to be attached is formed from a relatively rigid type of plastic in such an arrangement. The grip member may be as previously described.

According to a further aspect of the present invention there is provided a kit for feeding an infant which comprises an infant feeding device as described above, a feed reservoir and a tube which communicates with both the reservoir connection means and the feed reservoir.

It is preferred that the reservoir comprises a receptacle for liquid feed which is provided with a closure means which includes a port through which liquid feed may pass.

It is envisaged that the kit may be used in two main configurations that is, a gravity driven set up where the reservoir points downwards, and a suction setup where the infant sucks the feed from the reservoir through the feed tube. When the reservoir is in a gravity driven downward pointing orientation, the tube may be connected to the port in such a way that feed can flow from the reservoir through the tube to the infant feeding device.

It is preferred that a first end of the tube is connected to the reservoir connection means and a second end of the tube is connected to the port. Preferably, the means for connecting the port to the tube at the reservoir end of the tube is a similar spigot to that described above in relation to the reservoir connection means. Preferably, the spigot on the feed reservoir is formed integrally with a connector insert that is fitted in the reservoir opening. It is further preferred that the connector insert is held in the reservoir opening by means of a collar that secures it in place between the collar and the reservoir. It is yet further preferred that the collar is attached to the reservoir opening by means of a screw thread.

When used in a gravity driven set up, the length of feed tube can be shorter than in other uses. This is to prevent the infant from getting tangled in the tubing and potentially being hurt. Also, losses in pressure caused by narrow tubing mean that, for the gravity fed application, the tubing has to be sufficiently short to produce a meaningful flowrate of feed when the pressure head is not large.

With a suction setup, it is preferable that the feed tube extends to the base of the reservoir so that all the feed in the reservoir can be consumed while the reservoir is in an upright position. Alternatively, the preferred arrangement for a gravity driven set up may be converted to a suction set up by connecting a second tube, which extends to the base of the reservoir, to the port. This may be conveniently achieved by using a connector insert for the reservoir which is provided with two spigots on opposite sides of the insert which define the port and fitting the tube to one spigot projecting away from the reservoir and fitting the second tube to the second spigot which projects into the reservoir.

In order to equalise the pressure in the reservoir with atmospheric pressure when the infant feeds, the feed reservoir may be provided with means to allow air to enter the feed reservoir. Such means may take the form of grooves at the opening of the reservoir such that when the reservoir is closed air can still get into the reservoir but feed cannot get out. Another option, is to provide a pressure relief valve in the feed reservoir. It is preferable to locate the relief valve in the lid of reservoir as the reservoir will usually be in an upright position and there is therefore less chance of fluid surrounding the valve and escaping when the valve is in operation. Consequently, the valve may be located in the connector insert, adjacent to the feed tube spigot. The relief valve may comprise an aperture open to the external atmosphere and a slit valve beneath the aperture. It is preferable for the slit valve to be domed inwardly towards the interior of the reservoir and against the flow of fluid. The operation of the relief valve is similar to that of the valve employed in the feeding device so that, when there is a sufficient pressure difference across the valve in a favourable direction, the valve will let air into the reservoir to equalise the pressure drop caused by the removal of feed.

It is also envisaged that the main valve could be located in the feed reservoir instead of in the feeding device.

In another embodiment, it is envisaged that the feeding device and/or the reservoir could be shaped in such a way that the feeding device could be located on the reservoir when not in use. It is also envisaged that means could be provided for attaching the feeding device to the reservoir in such a way that feed could still flow from the reservoir to the feeding device. For instance, the tube could be designed to push into the resevoir and the screw thread on the reservoir opening could be made to correspond to that of the tubular adaptor of the feeding device. Thus, the mouthpiece may be directly attached to the reservoir by securing with the tubular adaptor. Alternatively, if the mouthpiece is provided with an integral corresponding thread, the mouthpiece may be attached directly to the reservoir. In either arrangement, the grip member may be formed as part of a ring which fits around the thread of the reservoir opening and be held in place by either the mouthpiece or tubular adaptor when fitted on the reservoir opening. In a further alternative, the reservoir or its lid could be provided with a flange on which the feeding device may be located. These embodiments provide the option of making a training cup directly from the parts provided.

It is further preferred that a hook or some form of attachment strap, preferably made of velcro, be provided on the feed tube so that, when longer lengths of tubing are used, the weight of the tube is partially supported by securing the hook or strap to another fixture.

In a further possible embodiment the reservoir may be formed with one or more tunnels in the body of the reservoir, preferably aligned in a direction generally perpendicular to the major axis of the reservoir so that the parts of the reservoir that form the surround of the tunnel can be utilised as handles. The tunnels may be offset to one side of the centreline and the handles formed may be of a size such that they can be gripped by an infant. The parts of the reservoir that form the handle may be hollow and joined to the central portion, hollow and empty and separated from the central portion or hollow and separated from the central portion and filled with a decorative filling such as pieces of glitter suspended in a coloured solution. Alternatively, they may be solid. When the reservoir is used with hot or cold fluids, the handles which are separated from the central portion provide an insulated holding means. Providing handles larger than the grip member of the feeding device for infants to grip the reservoir can be used as a further step in the training of an infant to use a normal cup.

Preferably, the kit further includes means for mounting the feed reservoir on a suitable support. For instance, a strap or harness may be provided which is adapted to secure the reservoir to the body of an adult, thereby releasing both hands of the adult to look after the infant while the infant feeds. Another preferred feature is to provide a band that can be removably attached to the reservoir, preferably by passing the band through one or more tunnels in the reservoir as described above, there being a hook attached to the band to allow the reservoir to be hung from a suitable support. It is further preferred that the hook be rotatably attached to the band so that the bottle can be secured in any desired orientation. It is even more preferable that the rotation means is biased to allow the hook to maintain an orientation that allows the reservoir to be held in a vertically down attitude or a vertically upright attitude.

In a further embodiment, the feed reservoir may be provided with a plurality of feeding devices so that more than one infant may feed at the same time from a single reservoir. It is envisaged that this could be particularly useful in the case of multiple births where a parent has to feed more than one infant or in the maternity ward of a hospital.

The invention also provides a feed reservoir as defined above for use in a kit according to the present invention as described above.

Specific embodiments of the invention will now be described by way of example and with reference to the accompanying drawings in which:

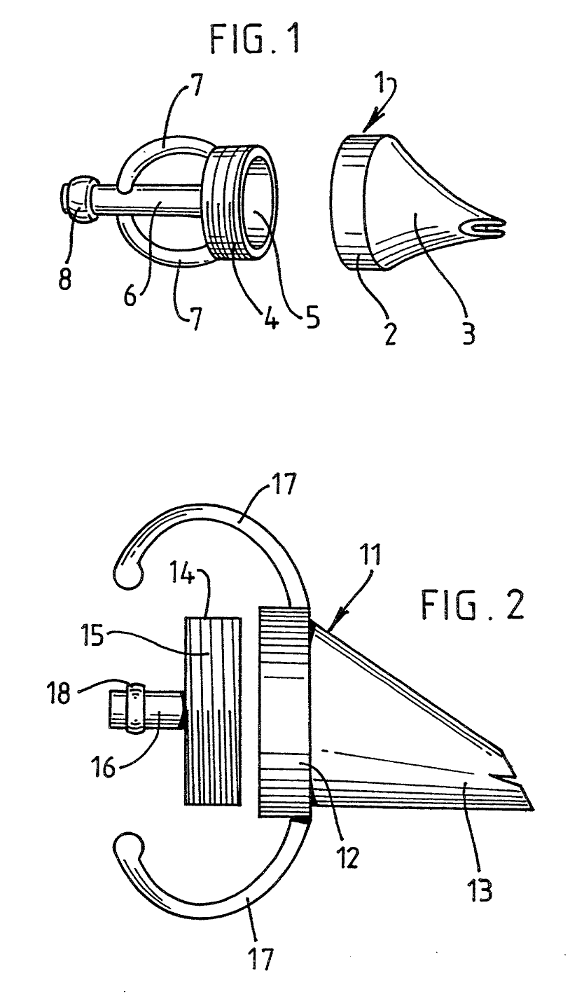

FIG. 1 is a perspective view of one embodiment of an infant feeding device according to the present invention;

FIG. 2 is a perspective view of a second embodiment of an infant feeding device according to the present invention;

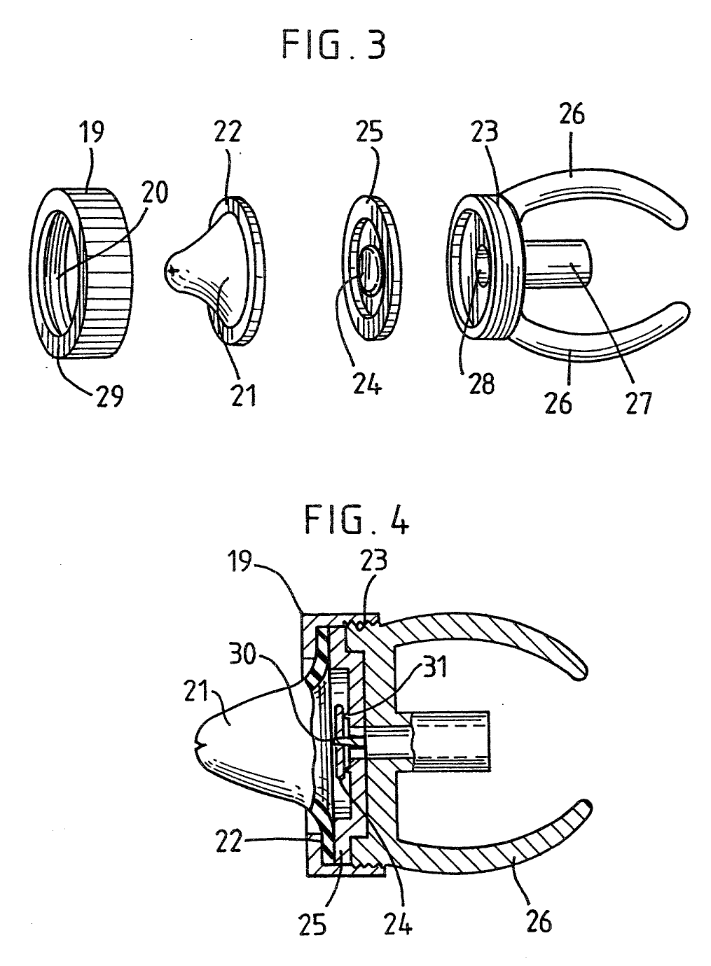

FIG. 3 is an exploded view of the components of a third embodiment of an infant feeding device according to the present invention;

FIG. 4 is a sectional view of the embodiment of FIG. 3 in assembled form;

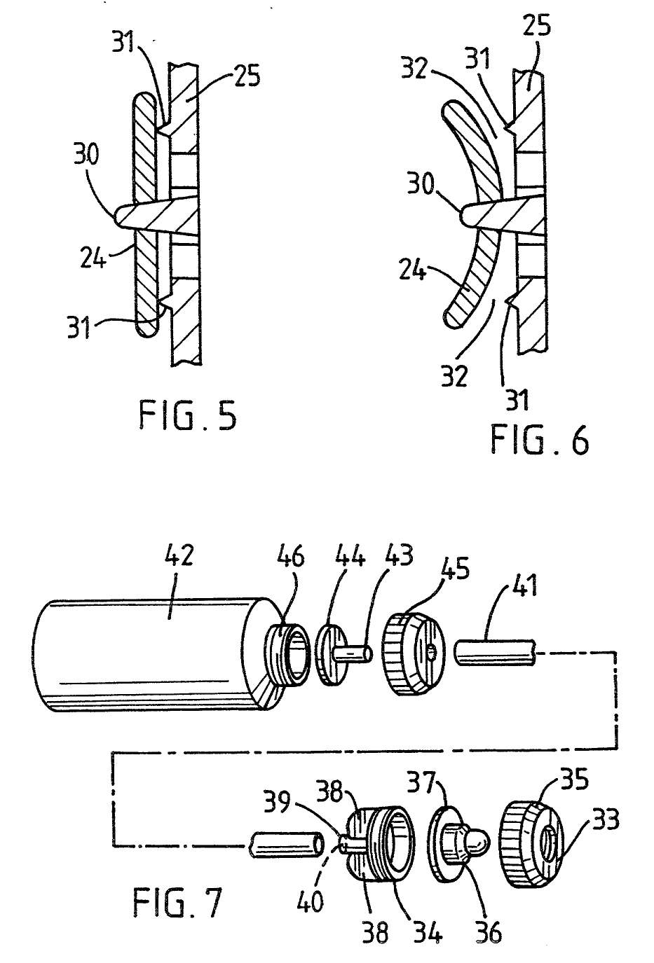

FIG. 5 is an enlarged view of part of FIG. 4 showing the valve in a closed position;

FIG. 6 is a view of the valve of FIG. 5 in an open position;

FIG. 7 is an exploded view of a kit for feeding an infant according to the present invention;

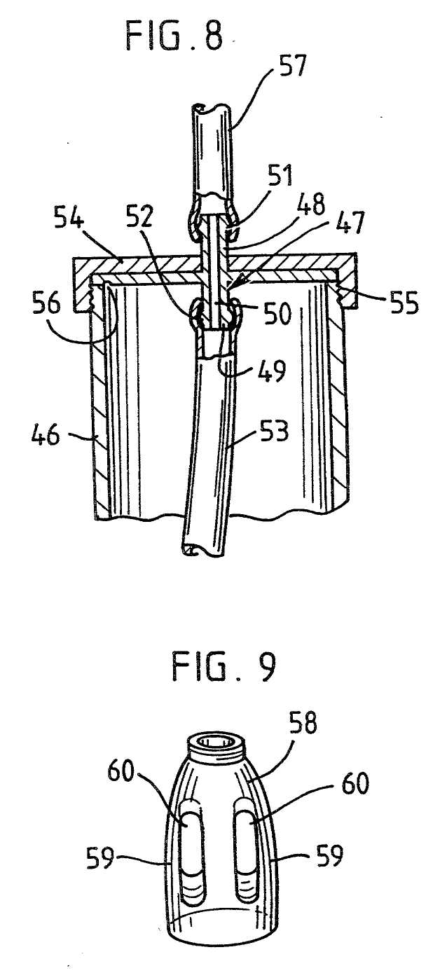

FIG. 8 is a sectional view of the top of one embodiment of a feed reservoir according to the present invention;

FIG. 9 is a perspective view of another embodiment of a feed reservoir according to the present invention;

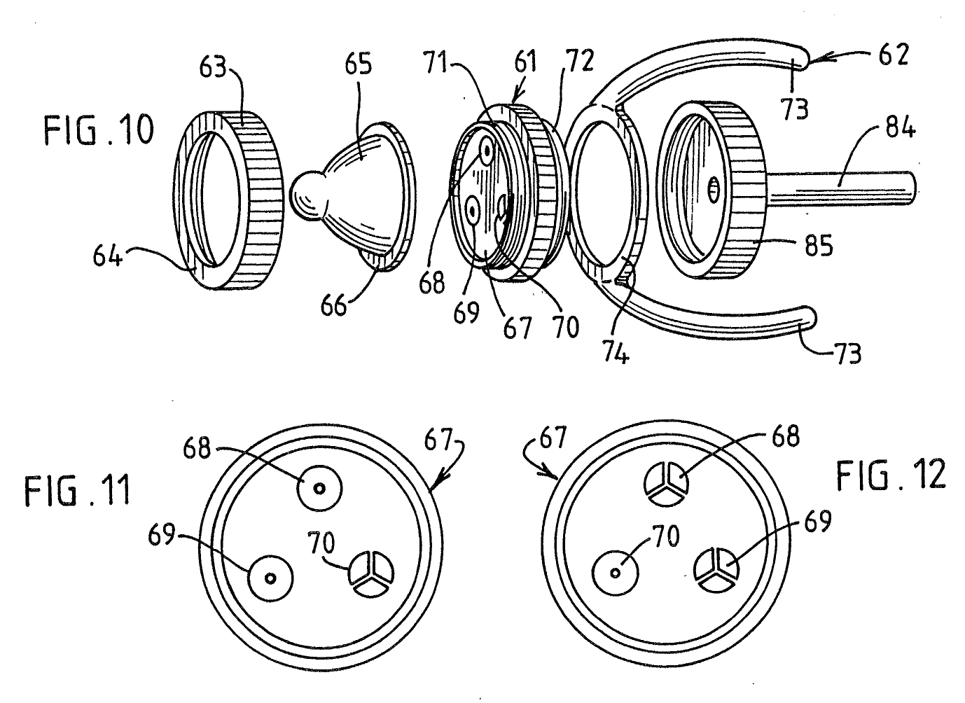

FIG. 10 is an exploded view of a further embodiment of an infant feeder according to the present invention;

FIG. 11 is a plan view of one side of the intermediate valve layer of FIG. 10;

FIG. 12 is a plan view of the opposite side of the intermediate valve layer of FIG. 10;

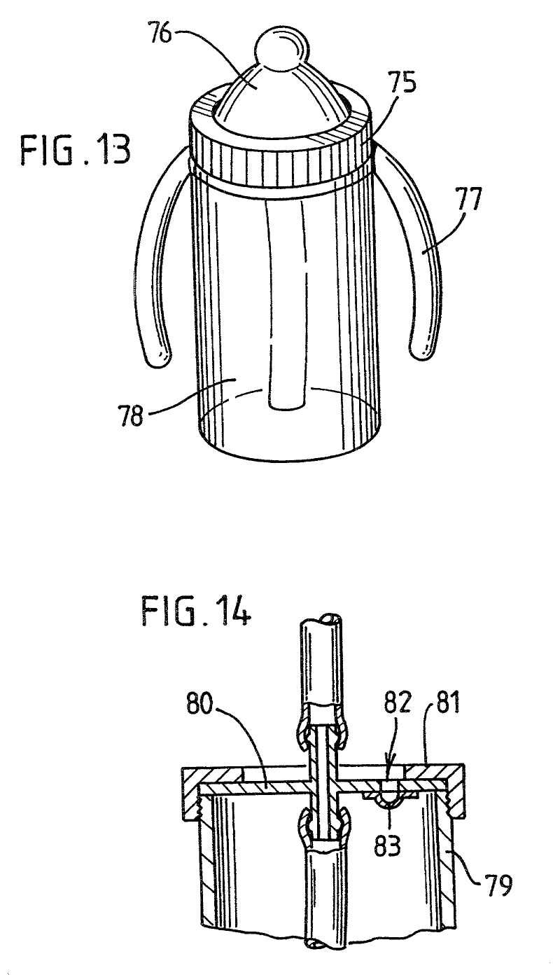

FIG. 13 is a perspective view of one embodiment of the infant feeder according to the present invention when it is converted into a conventional trainer cup; and

FIG. 14 is a sectional view of the top of another embodiment of a feed reservoir according to the present invention.

FIG. 1 shows a first embodiment of an infant feeding device 1 according to the present invention which comprises a tubular adaptor in the form of a screw cap 2 with an aperture (not shown) through which is inserted a mouthpiece in the form of a teat or soft spout 3. The screw cap 2 has internal threads which screw onto an externally threaded portion of reservoir connection means 4 thereby securing and sealing the teat or soft spout 3 in position. Reservoir connection means 4 comprises aperture 5, a centrally located spigot 6 with a ridge 8 and two grip members 7 in the form of closed loop elements which are individually positioned co-planarly on opposite sides of tube 6. Ridge 8 serves to secure a feed tube (not shown) which leads to a feed reservoir (not shown) to spigot 6. Components 4, 5, 6, 7 and 8 are formed integrally with one another. Grip members 7 are proportional to an infant's hand and fingers and are integral with and positioned on the base of the screw threaded portion of reservoir connection means 4. All components of the feeding device 1 are made from materials which are commonly utilised in infant feeding products, such as suitable plastics materials or, in the case of the mouthpiece, silicone rubber. In use, liquid feed passes through tube 6 and aperture 5 into mouthpiece 3 and then into the mouth of the infant.

FIG. 2 shows a second embodiment of an infant feeding device 11 according to the present invention which comprises a tubular adaptor in the form of an internally threaded screw cap 12 with an aperture (not shown) through which is inserted a mouthpiece in the form of a teat or soft spout 13. Two grip members 17 in the form of curved rods of generally half-elliptical shape extend downwards from screw cap 12 and are either moulded integrally with screw cap 12 or attached to screw cap 12 by a push fit arrangement. The internal screw thread of screw cap 12 screws onto an externally threaded portion of connector cap 15 of reservoir connection means 14 thereby sealing and securing the teat or soft spout 13 in position. Reservoir connection means 14 comprises a conduit 16 having a ridge 18, which serves as a means for securing a feed hose (not shown) to spigot 16, attached to an externally screw threaded connector cap as described above.

FIG. 3 shows the component parts of a third embodiment of an infant feeding device according to the invention. A tubular adaptor in the form of a collar 19 is provided with an internal screw thread 20 which corresponds to the external screw thread provided on reservoir connection means 23 and a flange 29. A mouthpiece in the form of a teat 21 is provided with a flange 22 around its circumferential edge. Teat 21 is made of silicone rubber. Insert 25 contains a valve 24 in the form of a mushroom valve which is made of a suitably is flexible material such as silicone rubber. Reservoir connection means 23 is provided with two grip members in the form of curved rods 26 and a spigot 27 having an aperture 28. To assemble the feeding device, teat 21 is inserted in collar 19 so that flange 22 of the teat 21 abuts flange 29 of collar 19. Valve insert 25 is also inserted in collar 19 behind teat 21. The externally threaded portion of reservoir connection means 23 is then screwed into the internally threaded portion 20 of collar 19 thereby securing teat 21 and valve insert 25 in position. In use, an infant sucking on teat 21 would cause the valve 24 to partially lift from insert 25 and allow feed to flow through the channel created by the lifting portion of valve 24. When the suction is removed the lifting portion of valve 24 falls again to seal the channel and stop the flow.

The arrangement of the valve 24 is shown in more detail in FIG. 4. Valve 24 is held in place in the centre of the aperture 28 of reservoir connection means 23 by a post 30 which is part of valve insert 25. The bottom surface of valve 24 is in contact with a protruding ridge 31 formed on the surface of insert 25, which forms a seal with valve 24 through which no feed can flow. The operation of the valve 24 is shown in more detail in FIGS. 5 and 6. FIG. 5 shows the valve 24 in a closed position whereas FIG. 6 shows the valve in an open position during operation of the feeding device. When the pressure difference across valve 24 is sufficient as a result of an infant sucking on the mouthpiece 21, valve 24 is deformed upwards slightly and forms a channel 32 through which feed can flow as shown in FIG. 6. When the pressure differential is removed, that is, when the infant stops sucking on the mouthpiece 21, valve 24 returns to the position shown in FIG. 5 and prevents further feed from passing.

FIG. 7 shows the component parts of a kit for feeding an infant according to the present invention. A tubular adaptor in the form of collar 33 is provided with an internal screw thread which corresponds to the external screw thread provided on reservoir connection means 34, and a flange 35. A mouthpiece in the form of teat 36 is provided with a flange 37 around its circumferential edge. Reservoir connections means 34 is provided with two grip members in the form of wings or tabs 38 and a spigot 39 having an aperture 40. Feed tube 41 links the feeding device to a feed reservoir in the form of a bottle 42. Tube 41 is of a sufficient internal diameter so that friction losses do not prevent the delivery of feed from the reservoir 42 to the feeding device, and possesses sufficient stiffness to prevent the tube 41 from forming a tight loop around an infant's neck whilst being flexible enough for easy manoeuvring. Feed tube 41 is connected to reservoir 42 by a spigot 43 similar to spigot 39, mounted on a connector insert 44. Connector insert 44 is attached to reservoir 42 by a collar 45. Collar 45 is provided with an internal screw thread which corresponds to the external screw thread 46 around the opening of reservoir 42 thereby enabling collar 45 to be screwed onto reservoir 42.

FIG. 8 shows a sectional view of the top of one embodiment of a feed reservoir for use with a feeding device according to the present invention which demonstrates how the feed tube may effectively be lengthened to reach the base of reservoir 46 to allow feeding without the aid of gravity, that is, by suction. Insert 47 has two spigots 48, 49, one on each side of insert 47, which together define a tube 50 through insert 47. Spigots 48, 49 are provided with ridges 51, 52 which act as means for securing feed tubes to the spigots so that the force required to remove the tubes is sufficient to prevent the tubes from being accidentally removed by an infant when in use but will allow the tubes to be easily detached by an adult for cleaning purposes. Other methods suitable for connecting a tube to a spigot can also be used, such as, a groove formed around the spigot securing a ridge on the inside surface of the tube etc. In use, feed tube extension 53 is connected to spigot 49 and is held in place by an internally screw threaded collar which screws onto an externally screw threaded portion 55 of the reservoir body 46. The feed tube extension 53 should be of a length such that it extends to the base of reservoir 46. Feed tube 57 which is connected to the feeding device, fits onto spigot 48 as described above. A groove 56 is left in the interior surface of insert 57 which matches a similar groove at the opening of reservoir 47 so that air can enter the reservoir when the feed is being removed and equalise any pressure difference.

FIG. 9 shows one embodiment of a feed reservoir 58 in which areas 59 are formed by creating tunnels 60 in the reservoir 58 in a direction perpendicular to the major axis of the reservoir. Areas 59 can act as grip members or can be utilised as a means of securing a support strap to reservoir 58.

FIG. 10 shows the components of another embodiment of a feeding device according to the invention which includes a tubular connector 61 containing a reversible valve insert and a separate grip member assembly 62. A tubular adaptor in the form of a collar 63 is provided with an internal screw thread which corresponds to the external screw thread provided on one end of tubular connector 61 and has a flange 64. A mouthpiece in the form of teat 65 is provided with a flange 66 around its circumferential edge. Tubular connector 61 is provided with a valve insert 67 in which valves 68, 69, 70 are located and has identical externally screw threaded portions 71, 72 at each end so connector 61 is effectively reversible. Valves 68, 69 operate in one direction of flow and valve 70 operates in the reverse direction of flow. Grip members 73 are attached to a ring 74 which fits onto screw threaded portion 71 or 72. Reservoir connection means in the form of collar 85 is provided with spigot 84 to which a feed tube may be attached. Alternatively, the reversible valve insert could be formed as part of a disc that could be inserted within the feeding device. In this embodiment, the tubular connector 61 could have a tubular spigot on the base obviating the need for threads 72 and collar 85.

FIG. 11 shows one face of the reversible valve insert 67. Valves 68, 69 only allow fluid to pass in a direction out of the page and valve 70 only allows fluid to pass in the opposite direction. These valves are shown here to be of a similar size, although they may differ in volume flowrate and activation pressure.

FIG. 12 shows the other opposite face of the reversible valve insert 67 shown in FIG. 11. When fitted into the feeding device in this orientation, the maximum flowrate of fluid into the mouthpiece is reduced when compared to the orientation shown in FIG. 11. The use of such a valve insert containing multiple valves makes a feeding device according to this embodiment suitable for a growing infant for a longer period than a feeding device with a single valve.

FIG. 13 shows an embodiment of the invention in which a kit comprising a feeding device, connecting tube and reservoir is converted into a conventional training cup. Grip members 77 are attached to an annulus which can fit around an externally screw threaded portion of the opening of reservoir 78. A tubular adaptor in the form of internally screw threaded collar 75 which contains mouthpiece 76 is screwed onto the externally threaded portion of reservoir 78 to form a trainer cup and the connecting tube is made to slide into the body of the reservoir 78. A valve insert (not shown) is also included in the feeding device. A trainer cup could also be formed from the elements of FIG. 10 in conjunction with a suitable reservoir. It is envisaged that this would be the penultimate stage in the training of an infant to adapt to the use of a normal cup. The final stage would be the removal of the valve insert.

FIG. 14 shows another embodiment of a feed reservoir 79 which is provided with an alternative method of equalising the pressure inside the reservoir with atmospheric pressure when feed is being taken. In this embodiment insert 80 is held in place at the top of the reservoir 79 by collar 81. An aperture 82 is formed in insert 80 and a slit valve 83 is provided underneath the aperture 82. The slit valve shown in this embodiment is domed inwardly, that is, convex in the direction of the interior for maximum prevention of leakage. A flat slit valve could be used when leakage from the slit valve is of less importance. The slit valve is made of a similar material to the mushroom valve and can be glued onto the underneath surface of insert 80 by a suitable non-toxic adhesive or heat welded to the insert 80. When the atmospheric pressure is above the interior pressure by a predetermined amount, the slit valve opens to equalise the pressure difference. The fluid inside is prevented from escaping through the valve by the domed shape which forces the material to first compress, and thus offer more reluctance to opening, before opening to the atmosphere.

It should be noted that the materials chosen in making all parts and embodiments of this invention need to be resilient to autoclaving and chemical attack by disinfectants used in repeated sterilisation procedures. Furthermore, they need to be non-toxic and capable of use delivering paediatric medicines that can be mixed with infant feed or soft drinks. Suitable materials typically include plastics materials and silicone rubber.

The invention has been described in detail herein by way of example only, and many variations are possible without departing from the spirit of the invention. Particularly, it should be appreciated that features described with reference to one embodiment may be used in others.

1. An infant feeding device comprising a mouthpiece adapted to deliver liquid feed to an infant, a grip member shaped to be easily grasped by an infant and means for connecting the mouthpiece to a feed reservoir.

2. A device according to claim 1 which further includes a tubular adaptor which is capable of receiving the mouthpiece.

3. A device according to claim 2 in which the tubular adaptor is capable of engaging the reservoir connection means.

4. A device according to claim 2 which further includes a tubular connector which is capable of engaging both the tubular adaptor and the reservoir connection means.

5. A device according to any one of the preceding claims in which the grip member is attached to the reservoir connection means.

6. A device according to any one of claims 1 to 4 in which the grip member is attached to the mouthpiece.

7. A device according to any one of claims 2 to 4 in which the grip member is attached to the tubular adaptor.

8. A device according to claim 4 in which the grip member is attached to the tubular connector.

9. A device according to any one of the preceding claims in which the grip member is attached to an annulus which is adapted to engage the mouthpiece, reservoir connection means, tubular adaptor or tubular connector.

10. A device according to any one of the preceding claims which further includes means for reducing or preventing air from entering the mouthpiece.

11. A device according to any one of the preceding claims which further includes a liquid flow control device.

12. A device according to claim 11 in which the liquid flow control device comprises a valve.

13. A device according to claim 11 or claim 12 in which the liquid flow control device is mounted in an insert, the insert being adapted for mounting in the device.

14. A device according to any one of the preceding claims in which the reservoir connection means comprises a tubular spigot.

15. A kit for feeding an infant which comprises a mouthpiece adapted to deliver liquid feed to an infant, a feed reservoir, means for connecting the mouthpiece to the feed reservoir, a tube which communicates with both the reservoir connection means and the feed reservoir and a grip member shaped to be easily grasped by an infant.

16. A kit according to claim 15 in which the grip member is attached to the tube.

17. A kit for feeding an infant which comprises an infant feeding device according to any one of claims 1 to 14, a feed reservoir and a tube which communicates with both the reservoir connection means and the feed reservoir.

18. A kit according to any one of claims 15 to 17 in which the feed reservoir comprises a receptacle for liquid feed which is provided with a closure means which includes a port through which liquid feed may pass.

19. A kit according to claim 18 in which a first end of the tube is connected to the reservoir connection means and a second end of the tube is connected to the port.

20. A kit according to claim 18 or claim 19 in which a second tube, which extends to the base of the feed reservoir, is connected to the port.

21. A kit according to any one of claims 15 to 18 in which the tube extends to the base of the feed reservoir.

22. A kit according to any one of claims 15 to 21 in which the feed reservoir is provided with means to allow air to enter the feed reservoir.

23. A kit according to any one of claims 15 to 22 which further includes means for mounting the feed reservoir on a suitable support.

24. A feed reservoir for use in a kit according to any one of claims 15 to 23.
